(19) United States
(12) Patent Application Publication
(10) Pub. No.: US 2015/0372996 A1
(43) Pub. Date: Dec. 24, 2015

(54) SLOTTED MESSAGE ACCESS PROTOCOL FOR POWERLINE COMMUNICATION NETWORKS

(71) Applicant: QUALCOMM Incorporated, San Diego, CA (US)

(72) Inventors: Sidney Brower Schrum, JR., Ocala, FL (US); Lawrence Winston Yonge, III, Summerfield, FL (US); Srinivas Katar, Fremont, CA (US); Hao Zhu, Milpitas, CA (US); Richard Ernest Newman, Gainesville, FL (US)

(21) Appl. No.: 14/743,836

(22) Filed: Jun. 18, 2015

Related U.S. Application Data
(60) Provisional application No. 62/015,085, filed on Jun. 20, 2014.

(51) Int. Cl. H04L 29/06; H04W 12/04; H04L 9/08

(52) U.S. Cl. CPC H04L 63/061; H04L 9/0838; H04L 63/0428; H04W 12/04

(57) ABSTRACT

A slotted message access protocol can be implemented for transmitting messages in a communication network. A beacon period may be divided into multiple communication slots. A master network device may register a first client network device and provide registration information to the first client network device. The registration information may include one or more encryption keys to allow the first client network device to securely transmit messages in the communication network. The client network device may use an encryption key associated with a second client network device to decrypt messages received from the second client network device. Furthermore, the first client network device may use a contention-based communication slot to request allocation of contention-free communication slots for subsequent transmissions. The master network device may temporarily allocate contention-free communication slots to the client network device for a specified duration.

### RELATED MATTERS

This application claims the priority benefit of U.S. Provisional Application Ser. No. 62/015,085 filed on Jun. 20, 2014.

### BACKGROUND

Embodiments of the disclosure generally relate to the field of communication networks and, more particularly, to a slotted message access protocol for powerline communication (PLC) networks.

Various types of vehicles, such as automobiles, typically include a collection of electric wires that provide communication signals or electrical power between components of the vehicle. The collection of electric wires in the vehicle may also include wires to implement low-rate data buses, such as a local interconnect network (LIN) bus and a controller area network (CAN) bus for intra-vehicular communications. However, LIN and CAN buses introduce additional wires and complex wiring harnesses into the vehicles, thus are typically undesirable to use for data communications.

Powerline communication allows electric power lines to be used as a communication medium to connect various network nodes together in local and wide area networks, in addition to distributing and conducting electric power. Since vehicles typically have an existing power distribution infrastructure, the existing power lines can be utilized for data communications and for connecting components of the vehicle to each other and to the Internet. However, vehicular communication systems typically have stringent latency and reliability requirements that are not supported by current PLC protocols such as those specified by the IEEE 1901 communication protocol and the HomePlug AV/AV2/GreenPHY communication protocol for broadband over powerline communication.

### SUMMARY

Various embodiments of a slotted message access protocol are disclosed. In one embodiment, the first network device of a communication network determines to register a second network device in the communication network. The first network device allocates a communication slot of a beacon period to the second network device for a key exchange based, at least in part, on the first network device determining to register the second network device. The first network device determines a device encryption key associated with the second network device from the key exchange performed during the communication slot. The first network device provides registration information to register the second network device in the communication network based, at least in part, on the device encryption key.

### BRIEF DESCRIPTION OF THE DRAWINGS

The present embodiments may be better understood, and numerous objects, features, and advantages made apparent to those skilled in the art by referencing the accompanying drawings.

FIG. 1 is an example block diagram including a mechanism for implementing S-MAP to transmit messages in a communication network;

FIG. 2 is an example block diagram including a mechanism for transmitting a message between network devices of a vehicle;

FIG. 3 is a flow diagram illustrating example operations for a master network device to securely register a client network device in a communication network;

FIG. 4 is a flow diagram illustrating example operations for a master network device to securely register a client network device in a communication network;

FIG. 5 is a flow diagram illustrating example operations for encrypting a message;

FIG. 6 is a flow diagram illustrating example operations for decrypting a message;

FIG. 7 is a flow diagram illustrating example operations for decrypting a message;

FIG. 8 is an example slot allocation schedule illustrating assignment of communication slots in a communication network;

FIG. 9 is a flow diagram illustrating example operations for contention reservation request/contention-free access of a communication medium;

FIG. 10 is a flow diagram illustrating example operations for processing multiple reservation request messages; and

FIG. 11 is a block diagram of one embodiment of an electronic device including a slot allocation mechanism for transmitting messages.

### DESCRIPTION OF EMBODIMENT(S)

The description that follows includes exemplary systems, methods, techniques, instruction sequences, and computer program products that describe various embodiments of the present disclosure. However, it is understood that the described embodiments may be practiced without specific details disclosed. For example, although some embodiments describe transmitting messages in a PLC network using HomePlug® AV/AV2/GreenPHY or IEEE 1901 communication protocols, the operations described herein can be extended to other wired communication protocols (e.g., multimedia over coax alliance (MoCA) protocols, Ethernet protocols, etc.) or wireless communication protocols (e.g., wireless local area network (WLAN) protocols such as IEEE 802.11 protocols). In other instances, well-known instruction instances, protocols, structures, and techniques have not been shown in detail in order not to obfuscate the description.

A powerline network is a shared communication network in which multiple network devices are coupled to the powerline medium. In addition to providing electric power, the powerline medium may also facilitate communications between PLC devices such as between network devices of a PLC network within a vehicle. The vehicle may be configured to use PLC protocols (e.g., HomePlug AV/AV2/GreenPHY protocols, IEEE 1901 protocols, etc.) for intra-vehicular communications. Using PLC protocols for communication can minimize the complexity of wiring harnesses and eliminate or reduce the need for additional data buses (e.g., a LIN bus and a CAN bus) in the vehicle.

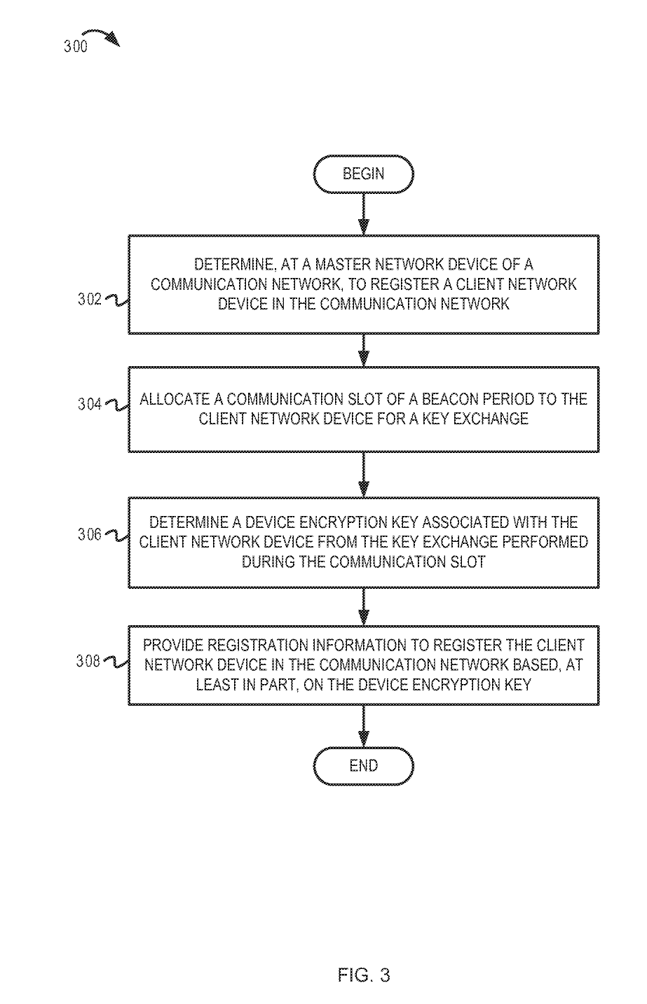

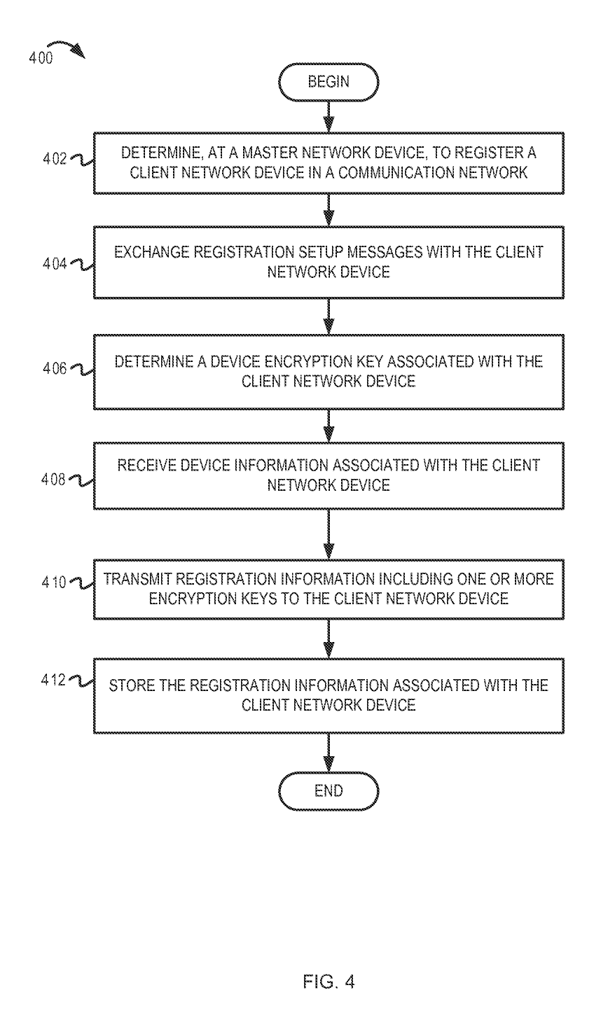

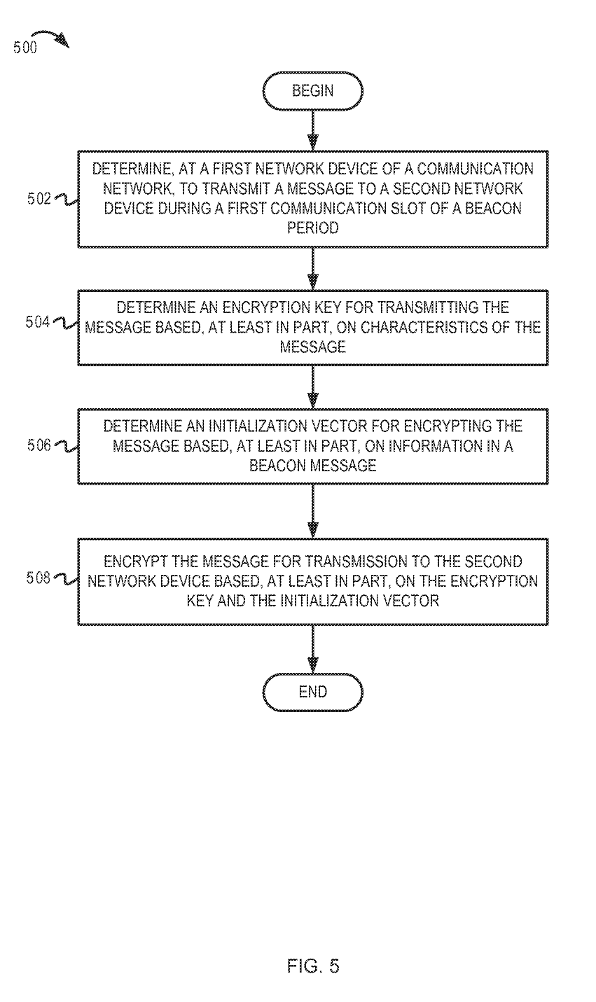

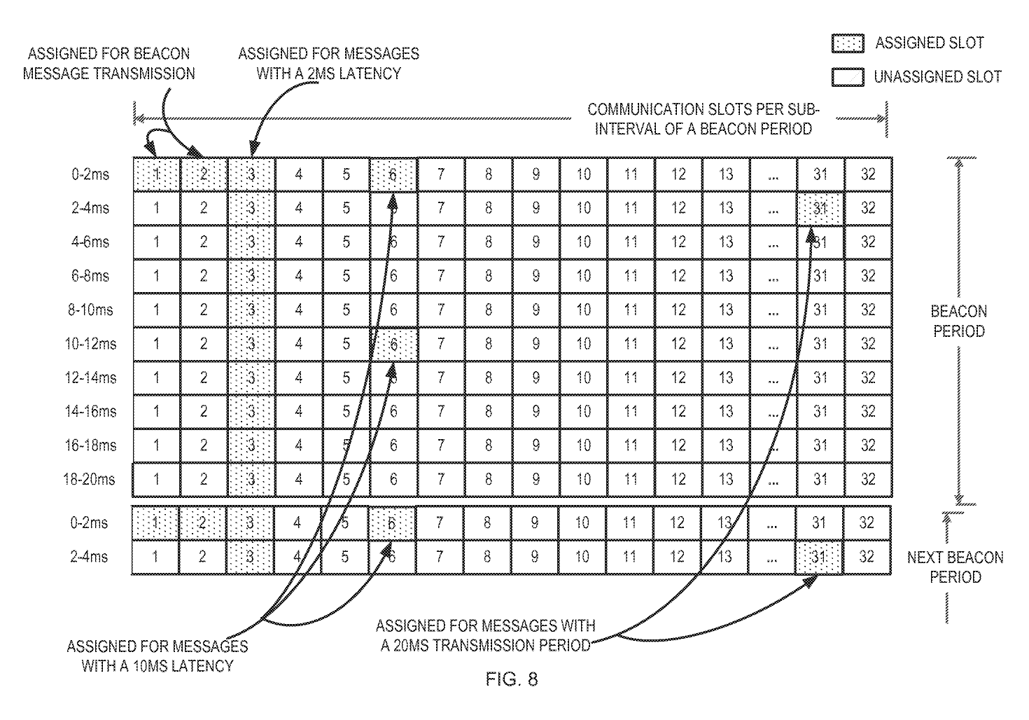

In some embodiments, a network device is configured to implement a slotted message access protocol (S-MAP) to efficiently transmit messages in a communication network. In S-MAP, the transmission time on a communication medium (“time-on-wire”) may be divided into communication slots (also referred to as “communication time slots” or “S-MAP slots”). A master network device may register a client network device in the communication network to implement S-MAP. As part of the registration operations, the master network device may distinguish between different client network devices (e.g., in terms of a device identifier) for subsequent communication with the client network devices. The master network device may assign encryption keys to a client network device for subsequent communication in the communication network. Additional disclosure regarding the registration operations will be described with reference to FIGS. 3 and 4. The master network device may assign communication slots to a client network device depending on different types of messages that will be transmitted by the client network device. A client network device may use the encryption keys to encrypt and decrypt messages for secure communication in the communication network, as will be described in FIGS. 5-7. Additionally, a hybrid medium access technique using both contention-based and contention-free communication slots may also be implemented, as will be described in FIGS. 8-10. A client network device may use a contention-based communication slot to request allocation of contention-free communication slots for subsequent transmission. The master network device may temporarily allocate contention-free communication slots to the client network device for a specified duration. The client network device may initiate subsequent transmissions in the contention-free communication slots for the specified duration. Adapting existing communication protocols to transmit messages during assigned communication slots can minimize overhead and message collisions, and improve communication efficiency and reliability.

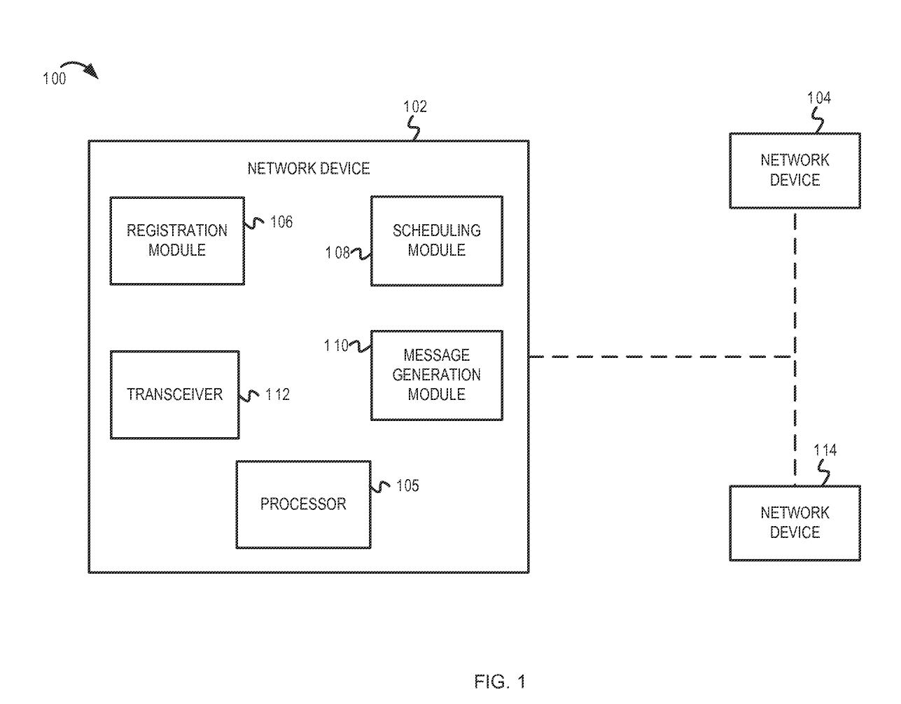

FIG. 1 is an example block diagram including a mechanism for implementing S-MAP to transmit messages in a communication network 100. The communication network 100 includes network devices 102, 104, and 114. The network device 102 includes a processor 105, a registration module 106, a scheduling module 108, a message generation module 110, and a transceiver 112. Although not shown in FIG. 1 for simplicity, the network devices 104 and 114 may also include a processor, registration module, a scheduling module, a message generation module, and/or a transceiver. The network devices 102, 104, and 114 may be communicatively coupled with each other using wired and/or wireless communication links, depicted in FIG. 1 using dashed lines. The network devices 102, 104, and 114 may communicate during communication slots that are allocated using S-MAP, as will be further described below.

In one embodiment, the communication network 100 is a PLC network and the network devices 102, 104, and 114 are PLC-capable devices. The network devices 102, 104, and 114 may be configured to operate using a HomePlug 1.0/AV/AV2/GreenPHY communication protocol, an IEEE 1901 communication protocol, an IEEE 1905 communication protocol, and/or another suitable PLC protocol. In addition to (or instead of) the PLC protocol, the network devices 102, 104, and 114 may be configured to implement other suitable wired communication protocols (e.g., Ethernet protocols, MoCA protocols, etc.) and/or wireless communication protocols (e.g., WLAN protocols, such as IEEE 802.11 protocols).

In one embodiment, the network device 102 is a master network device and the network devices 104 and 114 are client network devices. In other embodiments, any one of the network devices 102, 104, and 114 can be the master network device and the remaining network devices can be the client network devices. In some embodiments, the registration module 106 includes instructions that, when executed by the processor 105, register a client network device and provide registration information to the client network device. The registration information can include a device identifier of the client network device, encryption keys for transmitting and receiving messages, communication slots for transmitting and receiving messages, and so on. The registration module 106 may also perform a key exchange to determine one or more encryption keys associated with the client network device. In some embodiments, the registration module 106 includes instructions that, when executed by the processor 105, exchange various registration messages with a master network device and receive registration information from the master network device to be used for subsequent communication. Although examples describe the master network device registering a client network device, in other embodiments, a previously registered client network device may be configured to register an unregistered client network device in the communication network. The registration operations will be further described in FIGS. 3 and 4.

In some embodiments, the scheduling module 108 includes instructions that, when executed by the processor 105, allocate communication slots for contention-free access and/or contention-based access of the communication medium. The communication slots that are allocated for contention-free access may also be referred to as “contention-free communication slots.” The communication slots that are allocated for contention-based access may also be referred to as “contention-based communication slots.” The scheduling module 108 may allocate the communication slots based on certain parameters (e.g., number, type, frequency, and/or latency) relating to messages that will be transmitted by the client network device. The scheduling module 108 may allocate the communication slots during the registration operations or after the registration operations are completed. Communication slots allocation will be described in FIGS. 8-10. In some embodiments, the scheduling module 108 also includes instructions that, when executed by the processor 105, select a contention-free communication slot or a contention-based communication slot for transmitting a message.

In some embodiments, the message generation module 110 includes instructions that, when executed by the processor 105, encrypt and decrypt messages for secure communication of messages. The message generation module 110 may encrypt/decrypt a message based, at least in part, on an encryption key and/or the information in the beacon message. In some embodiments, the message generation module 110 receives the encryption key from the master network device as part of the registration information. In other embodiments, the message generation module 110 determines the encryption key during the registration operations. Message encryption and decryption will be described in FIGS. 5-7.

In some embodiments, the message generation module 110 further includes instructions that, when executed by the processor 105, determine a suitable message format for transmitting data in the communication network. The message generation module 110 may use the determined message format to generate a message for transmission during a communication slot assigned to the network device. For example, the message generation module 110 may generate a message using a short message format to transmit a short payload via an automotive bus to control certain functions in a vehicle (e.g., to control a vehicle entertainment system, open/close doors, adjust vehicle mirrors, and so on). A short payload is a payload that has a length that is less than or equal to a threshold payload length. The threshold payload length may be a threshold number of bytes. In one example, a short payload is a payload having a number of bytes that is less than or equal to 12 bytes. It is noted that a message may generally refer to a physical layer protocol data unit (PPDU), a medium access control (MAC) protocol data unit (MPDU), a frame, or a packet. For example, the message may be a PLC PPDU for HomePlug communication protocols.

The transceiver 112 may include a receiver and a transmitter. The receiver and the transmitter may be implemented on the same integrated circuit (IC), as separate components on the same chip, or as separate components on distinct chips. The receiver may include an analog front end (AFE) that includes an amplifier to amplify received signals, a filter to remove unwanted frequencies from the received signals, a mixer to down-convert the received signal, an automatic gain control (AGC) module, and an analog-to-digital converter (ADC). The receiver may also include a fast Fourier transform (FFT) module to convert the received signal from a time domain representation to a frequency domain representation and/or a decryption and decoding module. The transmitter may include an AFE that includes an amplifier to amplify signals to be transmitted, a filter to remove unwanted frequencies from the signals to be transmitted, a mixer to up-convert the signal to an appropriate transmission frequency, and a digital-to-analog converter (DAC). The transmitter may also include an inverse fast Fourier transform (IFFT) module to convert the signal to be transmitted from a frequency domain representation to a time domain representation and/or an encryption and encoding module.

In some embodiments, the network devices 102, 104, and 114 are electronic devices, such as a desktop computer, a laptop computer, a tablet computer, a mobile phone, a smart appliance, a navigation device, a media player, a gaming console, a network bridging device, an access point, or other electronic devices that implement wired and/or wireless communication protocols. One or more of the network devices 102, 104, and 114 may be a standalone or dedicated PLC device that directly connects to an alternating current (AC) outlet (not shown) of a PLC network. In some embodiments, the network devices 102, 104, and 114 are part of a communication network of a vehicle, machinery, or other electronic system.

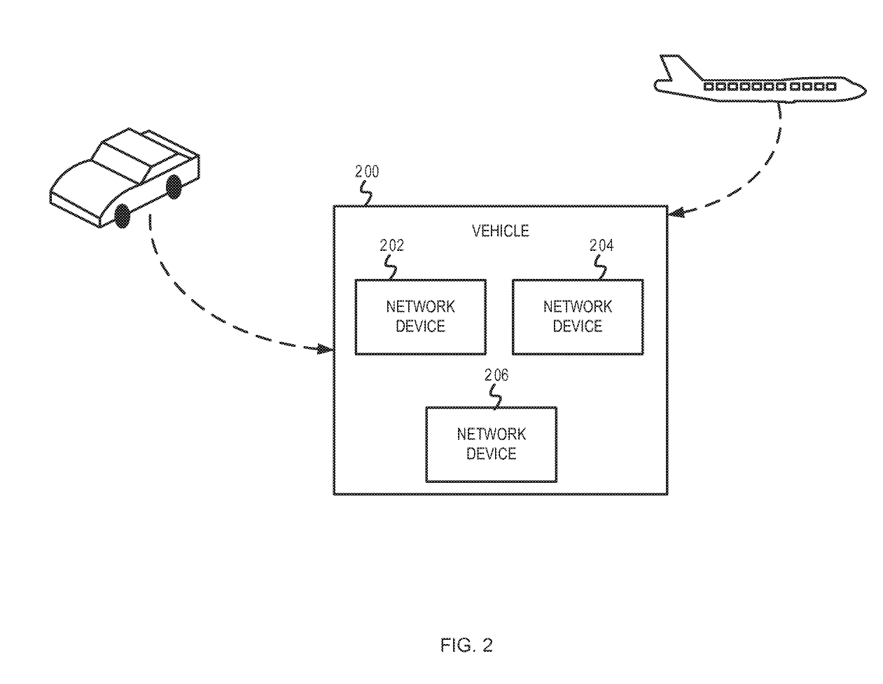

The communication network 100 can be implemented in a vehicle 200 as depicted in FIG. 2. The vehicle 200 includes network devices 202, 204, and 206. The network devices 202, 204, and 206 may be configured similarly to the network device 102 of FIG. 1. The vehicle 200 may be an electric vehicle, a plug-in electric vehicle (PEV), a hybrid electric vehicle, a gas-powered vehicle, an aircraft, electronic machinery, etc. The network devices 202, 204, and 206 may be electronic devices/components of the vehicle 200, such as the vehicle's central computer, heating and cooling system components, charging and battery system components, entertainment devices, security system components (e.g., windows, door locks, alarm, etc.), and/or other suitable electronic devices/components. The network devices 202, 204, and 206 implement S-MAP for internal communications within the vehicle 200 via an automotive bus. For example, the network devices 202, 204, and 206 can implement S-MAP to control various operations of a vehicle, such as adjusting vehicle mirrors, opening/closing vehicle doors, switching ON/OFF lights on the vehicle, etc. The automotive bus may be a PLC medium (i.e., electric wires) that couples the network devices 202, 204, and 206 within the vehicle 200. Although FIG. 2 depicts the vehicle 200 including three network devices 202, 204, and 206, the vehicle 200 may include any suitable number of network devices configured to implement S-MAP.

S-MAP may be a time domain multiple access (TDMA) based protocol that divides transmission time on the communication medium into communication slots. In some embodiments, a beacon period is divided into multiple communication slots as depicted with reference to FIG. 8. The number of communication slots within the beacon period may be determined based, at least in part, on the communication protocol that is being implemented or may be configurable. For example, the beacon period may be 33.3 ms when the HomePlug GreenPHY communication protocol is implemented. In another example, the beacon period may be configured to be 20 ms. In this example, the beacon period is divided into 320 communication slots, each communication slot having a duration of 62.5 μs. Although the example describes each communication slot of a beacon period having the same duration, some/all the communication slot of the beacon period may have a different duration. The master network device (also referred to as “coordinating network device”) may allocate one or more of the communication slots per beacon period for transmitting a beacon message. The beacon message may be transmitted at the beginning of a beacon period or any suitable number of communication slots located in suitable positions in the beacon period (e.g., middle of the beacon period, end of the beacon period, etc.).

In some embodiments, the master network device transmits a beacon message every beacon period in reference to a local physical layer (PHY) clock associated with the master network device. The beacon message may provide a timing reference so that client network devices can estimate the start/stop time instants of their respective communication slots. A client network device may synchronize its local PHY transmit/receive clocks to the PHY clock of the master network device based on time instants at which the client network device receives beacon messages from the master network device. The client network device may use multiple instances of beacon message reception to estimate the timing difference at the client network device and to synchronize its local PHY clocks with the PHY clock of the master network device. To enable PHY clock synchronization at the client network device, the master network device may derive the time instant for transmitting the beacon message and the PHY clock timing from the same clock at the master network device.

The master network device may assign one or more contiguous communication slots of the beacon period to client network devices to allow the client network devices to transmit management or data messages. The data messages may be application data messages. In other embodiments, the communication slots that are allocated to a client network device in a beacon period may not be contiguous. A beacon period may be associated with an identifier (“beacon period identifier”) such as a beacon period number. The master network device may select the beacon period identifier and indicate the beacon period identifier in the beacon message. For example, the master network device may select a beacon period identifier at start-up and increment the beacon period identifier for each subsequent beacon period. The beacon period identifier may be randomly selected, predetermined, or selected based on certain criteria. Additionally, each communication slot within the beacon period may also be associated with a communication slot identifier, also referred to as “slot identifier.” The master network device may assign a subset of the communication slots per beacon period to a client network device (or to groups of client network devices). Alternatively, the master network device may assign one or more communication slots to a client network device every N beacon periods. Communication slots that are not assigned to any client network device may be reserved for dynamic slot allocation or for future allocation to client network devices (e.g., plug-and-play devices that connect to the vehicle).

The master network device may generate a slot allocation schedule (also referred to as an S-MAP schedule). FIG. 8 illustrates one example of the slot allocation schedule. The slot allocation schedule can indicate communication slots assigned to the network devices (or groups of network devices), the type of messages that can be transmitted in each communication slot, the class of traffic (“traffic class”) that can be transmitted in each communication slot, and/or the medium access techniques that should be employed for communicating in each communication slot. The type of message may refer to the content of the message, such as whether the message is a heating and cooling system control and/or status message, charging and battery control and/or status message, entertainment device control and/or status message, security system control and/or status message, etc. In some embodiments, the master network device transmits the slot allocation schedule in a beacon message or in a broadcast management message to registered client network devices. In some embodiments, the master network device transmits in a unicast message to a client network device, a portion of the slot allocation schedule that is relevant to the client network device. The portion of the slot allocation schedule may indicate when the client network device can transmit different types/classes of messages and when the client network device should listen for messages. The master network device may wait for an acknowledgement (e.g., an application level acknowledgement) in response to transmitting the unicast message including the portion of the slot allocation schedule to the client network device. The master network device may retransmit the unicast message if the acknowledgement is not received within a timeout interval.

The master network device may also transmit slot allocation schedule updates after the master network device registers a client network device. The master network device may periodically update the slot allocation schedule (e.g., every X hours, every Y days, etc.). The master network device may also update the slot allocation schedule if the configuration of a client network device changes, if a client network device is added to or removed from the communication network, and/or if a component or feature is added/removed from the vehicle, etc. The client network devices may use the slot allocation schedule to determine when to initiate their respective transmissions and when to listen for transmissions from other client network devices.

The master network device may provide a wake/sleep schedule to a registered client network device. In some embodiments, the client network devices determine their respective wake/sleep schedule based, at least in part, on the slot allocation schedule provided by the master network device. For example, the client network devices may operate in the active operating state during the communication slots that are allocated for transmitting/receiving relevant messages (as indicated in the slot allocation schedule). The client network device may determine the wake/sleep schedule based, at least in part, on the portion of the slot allocation schedule received in a unicast message from the master network device. For example, the client network device may remain in the active operating state only during the communication slots allocated for receiving messages and for transmitting messages (when the client network devices has messages to transmit). In some embodiments, the master network device transmits a wake/sleep schedule that is separate from the slot allocation schedule. The wake/sleep schedule may indicate the communication slots in a beacon period during which the client network device should operate in the active operating state to transmit or receive messages. The client network device may transition to a low power operating state or a “sleep operating state” during the communication slots when the client network device is not scheduled to transmit/receive messages. During the sleep operating state, the client network device may disable one or more components or configure one or more components in a low power operating state. The client network devices may not receive messages when configured in the sleep operating state. If the client network device is not scheduled to transmit/receive messages for extended periods of time (e.g., multiple beacon periods), the client network device may transition to a “deep sleep” (or inactive) operating state. A majority of the communication and/or processing components of the client network device may be disabled in the deep sleep operating state. The sleep operating state may be an intermediate operating state between the active operating state and the deep sleep operating state. The time to transition from the sleep operating state to the active operating state may be shorter than the time to transition from the deep sleep operating state to the active operating state. Furthermore, the master network device may optimize the slot allocation schedule and the wake/sleep schedule to maximize the amount of time that each client network device is configured in the sleep operating state to minimize power consumption in the communication network. In some implementations, the master network device may selectively place the entire communication network (e.g., the automotive bus of a vehicle) in a deep sleep operating state. All communications in the communication network may cease for multiple beacon periods when the entire communication network is in the deep sleep operating state.

In addition to generating and distributing the wake/sleep schedule and the slot allocation schedule, the master network device may also register a client network device in the communication network, assign device identifiers (e.g., terminal equipment identifier or TEI) to the registered client network device, and distribute one or more encryption keys to the registered client network device. A client network device may register with the master network device before transmitting messages (e.g., data) in the communication network. Registration operations of the master network device and the client network device are further described in FIGS. 3 and 4.

FIG. 3 is a flow diagram (“flow”) 300 illustrating example operations for a master network device to securely register a client network device in a communication network. The flow begins at block 302.

At block 302, a master network device of a communication network determines to register a client network device in the communication network. In some embodiments, the master network device (e.g., a first network device) initiates the registration operations to register the client network device (e.g., a second network device) in response to receiving a registration request from the client network device. The registration request may include a first temporary identifier (TID) selected by the client network device. The first TID may be randomly selected, predetermined, or selected based on certain criteria. In another embodiment, the master network device initiates the registration operations in response to user input or during the manufacturing process. The flow continues at block 304.

At block 304, the master network device allocates a communication slot of a beacon period to the client network device for a key exchange. The master network device may allocate one or more communication slots to the client network device for transmitting key exchange messages (“key exchange communication slot”). A first key exchange communication slot allocated to the client network device and a second key exchange communication slot allocated to the master network device may be close to each other in time within the beacon period. For example, the first key exchange communication slot and the second key exchange communication slot may be separated by a time interval that does not exceed a threshold. Furthermore, the key exchange communication slot allocated to the client network device may be located prior to the key exchange communication slot allocated to the master network device within the beacon period. The master network device can minimize the possibility of a man-in-the-middle attack by exchanging messages with the client network device in communication slots that are close to each other in time. The key exchange communication slots may be used for negotiating an encryption key. The flow continues at block 306.

At block 306, the master network device determines a device encryption key (DEK) associated with the client network device from the key exchange performed during the one or more communication slots. In one embodiment, the master network device and the client network device perform a Diffie-Hellman DEK exchange to generate a common secret key referred to as the DEK. Alternatively, the master network device and the client network device may perform other suitable key exchange techniques to generate the DEK. The client network device may initiate the key exchange with the master network device by transmitting a key exchange request to the master network device during the key exchange communication slot allocated to the client network device. The master network device may transmit a key exchange response to the client network device during the key exchange communication slot allocated to the master network device. The DEK may be generated for secure communication with the client network device. The client network device may use the DEK to encrypt unicast messages for transmission to the master network device (e.g., during the registration operations). The master network device may use the DEK associated with the client network device to encrypt unicast messages intended for the client network device. For example, the master network device and the client network device may use the DEK to encrypt subsequent registration messages.

In some embodiments, the master network device determines the physical layer (PHY) channel characteristics associated with the client network device based on registration messages, data messages including predetermined data, and/or other suitable messages received from the client network device. The master network device may determine whether these PHY channel characteristics are consistent with those of an expected registering client network device. The master network device may terminate the key exchange and the registration operations if the PHY channel characteristics do not match. In some embodiments, certificates are used to authenticate the master network device and the client network device. For example, the master network device receives a certificate from a tail light module of a vehicle (i.e., the client network device) to register the tail light module. The master network device may validate the certificate before initiating the key exchange. The flow continues at block 308.

At block 308, the master network device provides registration information to register the client network device in the communication network based, at least in part, on the device encryption key. The registration information may include a device identifier, a slot allocation schedule, a wake/sleep schedule, an indication of whether the client network device is designated as a relay device, one or more encryption keys, etc. The device identifier may be a TEI that is unique on the communication network and that can be used to identify the client network device after successful registration. The TEI may be an 8-bit device identifier or may include any suitable number of bits. Additionally, one or more TEIs may be reserved as “special TEIs” and may not be assigned to any registered client network devices. For example, the TEI 0x00 may represent client network devices that have not been registered by the master network device; the TEI 0x01 may be assigned to the master network device; the TEI 0xFF may represent a broadcast TEI for broadcast communications; and so on.

The master network device may also indicate whether the client network device is designated as a relay device and other related information such as the type of messages the client network device is configured to relay and which communication slots should be used for relaying the messages. The master network device may designate any client network device as a relay device irrespective of the actual function performed by the client network device. For example, LED modules, door lock switches, etc. may be designated as relay devices. The master network device may designate the relay devices based on the topology of the communication network. If the topology of the communication network changes, the master network device may change the client network devices that are designated as relay devices. The relay devices may be designated when the vehicle is manufactured/designed, and may be configurable (e.g., by dealerships) when additional network devices are added to the vehicle. The master network device may select multiple client network devices to relay the same messages during the same communication slots.

In some embodiments, the master network device provides one or more group encryption keys (GEKs) to the client network device to enable the client network device to encrypt and decrypt messages exchanged with other network devices. A GEK may be used to encrypt multicast management messages and/or data messages. The master network device may generate the GEKs for each client network device in the communication network. The master network device can transmit one or more GEKs to the client network device in a unicast message that is encrypted using the DEK associated with the client network device. When the client network device is designated as a relay device, the GEKs may be provided to the relay device. The relay device may use the GEKs for decrypting messages that will be relayed to another network device. The master network device may also indicate which GEKs should be used to encrypt messages that are transmitted by the client network device. The registration information may also include a slot allocation schedule indicating communication slots allocated to the client network device for different types of communications and/or a wake/sleep schedule associated with the client network device. The TEI, the DEK, the GEKs, the slot allocation schedule, the wake/sleep schedule, an indication of whether the registered client network device is also designated as a relay device, and/or other suitable information may collectively or individually be referred to as registration information. The master network device may transmit the registration information to the client network device using a DEK encrypted message. From block 308, the flow ends.

FIG. 4 is a flow diagram 400 illustrating example operations for a master network device to securely register a client network device in a communication network. The flow 400 begins at block 402.

At block 402, a master network device determines to register a client network device in a communication network. In one embodiment, the master network device initiates the registration operations in response to receiving a registration request from the client network device or receiving a user input. In another embodiment, the master network device performs the registration operations during the manufacturing process.

A client network device may undergo either static registration or dynamic registration to join the communication network and transmit messages in the communication network. Static registration may be used for client network devices that are installed as part of the vehicle. For example, built-in processing and control modules such as lighting control modules, ignition control module, door/window activation modules, etc. may be “statically” registered. Because these client network devices are part of the vehicle, the registration information (e.g., the slot allocation schedule, device identifiers, etc.) used by these client network devices to operate in the communication network may also be static. The static registration information may be stored in non-volatile memory and the client network device may re-use the registration information to transmit messages in the communication network without having to re-register with the master network device. The client network devices can start to operate faster by eliminating or decreasing the need to re-register. For example, a lighting control module may re-use previously determined registration information each time the vehicle is started or the lighting control module is powered up.

Dynamic registration may be used for client network devices that are peripheral to the vehicle, such as client network devices that gain access to the communication network (e.g., automotive bus) by plugging into a 12-Volt convenience outlet, a diagnostic access port connector, a universal serial bus (USB) port, etc. For dynamic registration, the registration information may remain valid as long as the client network device and the master network device remain powered-on and/or the client network device remains attached to the communication network (e.g., the automotive bus). Dynamic registration may be performed each time a client network device is connected to the communication network (e.g., each time a client network device is plugged into the convenience outlet of a vehicle). For dynamic registration, the registration information used in a previous communication session may not be valid for use in a current or future communication session. The flow continues at block 404.

At block 404, the master network device exchanges registration setup messages with the client network device. The master network device may receive a registration request from the client network device. The registration request may include a first temporary identifier (TID) of the client network device. The TID may be randomly selected by the client network device, predetermined, or selected based on certain criteria. After receiving the registration request, the master network device may assign (or allocate) a second temporary identifier and at least one temporary communication slot to the client network device. In some embodiments, the second temporary identifier is a temporary TEI. The temporary communication slots may be assigned to the client network device for exchanging registration messages during the registration operations. In some embodiments, the temporary communication slots are contention-free communication slots during which other registered or non-registered client network devices may not transmit messages. In other embodiments, the temporary communication slots are contention-based communication slots and the client network device may contend with other non-registered client network devices to gain control of the temporary communication slots. The client network device may transmit subsequent registration messages after gaining control of the temporary communication slots. The master network device may allocate at least one key exchange communication slot to the client network device for transmitting key exchange messages. The master network device can provide the second temporary identifier, an indication of the temporary communication slots, and an indication of the key exchange communication slots to the client network device as part of a registration response. The temporary communication slots and/or the key exchange communication slots may be included as part of a temporary communication schedule that is provided to the client network device during the registration operations. The registration response may include the first temporary identifier received from the client network device to indicate that the registration response is intended for the client network device. The master network device may use the second temporary identifier to exchange subsequent registration messages with the client network device in the temporary communication slots. The key exchange communication slots may be close to each other in time (within the beacon period) and may be used for negotiating an encryption key, as described with reference to FIG. 3. The flow continues at block 406.

At block 406, the master network device determines a device encryption key associated with the client network device. The master network device and the client network device may execute a key exchange to generate the device encryption key, as described above with reference to FIG. 3. The master network device may transmit/receive key exchange messages to/from the client network device in key exchange communication slots, as described above. The flow continues at block 408.

At block 408, the master network device receives device information associated with the client network device. The device information associated with the client network device can refer to a part number, a serial number, another suitable identifier, or other information specific to the client network device. The client network device may also include the second temporary identifier to indicate that the client network device transmitted the device information. The device information may be received during a communication slot indicated in the temporary communication slots. The master network device may use the device information to determine the function of the client network device. This can allow the master network device to allocate a suitable number of communication slots and determine other registration information (e.g., TEI) for the client network device. The flow continues at block 410.

At block 410, the master network device transmits to the client network device registration information including one or more encryption keys associated with the client network device. The master network device may determine the registration information for the client network device as described above in FIG. 3. The master network device may transmit the registration information to the client network device using a DEK encrypted message. The master network device may use the second temporary identifier assigned to the client network device to indicate that the registration information is intended for the client network device. The master network device may also transmit the registration information in one or more temporary communication slots assigned to the client network device. The flow continues at block 412.

At block 412, the master network device stores the registration information associated with the client network device. The registration information may be stored in an appropriate data structure depending on whether the client network device is statically or dynamically registered. When the client network device is statically registered, some or all of the registration information (e.g., the DEK, TEI, the slot allocation schedule, etc.) may be stored in non-volatile memory for use across multiple power on/off cycles. At power-up, the master network device may also transmit management messages to provide additional information (e.g., beacon period identifier, etc.) to allow statically registered client network devices to rapidly start operating on the communication network. The master network device may communicate registration information updates in management messages or beacon messages during start-up, periodically, on demand, or when new information is available.

When a client network device is dynamically registered, the registration information may remain valid as long as the master network device and the client network device remain powered-on and/or the client network device remains connected to the communication network. The master network device may store the registration information associated with the dynamically registered client network device in volatile memory. The dynamically registered client network device may register and derive the DEK each time a new communication session is initiated. However, for both the statically registered client network device and dynamically registered client network device, the GEKs may be generated and provided by the master network device for each communication session. After storing the registration information in the appropriate data structure, the master network device may discard the second temporary identifier and temporary communication slots that were assigned to the client network device at the beginning of the registration operations. From block 412, the flow ends.

In some embodiments, the master network device requests user confirmation prior to transmitting the registration information to the client network device. For example, the master network device can present a notification requesting the user to confirm whether the client network device should be registered in the communication network. As another example, the client network device may perform an operation (e.g., switch ON/OFF a light/LED, operate a door lock, open/close a window, power ON the air-conditioning module, etc.) to help the user identify which client network device is being registered. If the user declines or indicates that the client network device should not be registered, the master network device can terminate the registration operations, revoke the second temporary identifier and the temporary communication slots, and discard the registration information.

In some embodiments, a dynamically registered client network device periodically indicates its presence in the communication network to the master network device. The master network device may use a message timeout to determine whether the dynamically registered client network device has left the communication network. If the dynamically registered client network device does not have any messages to transmit, the dynamically registered client network device may transmit an empty (“dummy”) message to maintain its dynamic registration. If the master network device does not receive a message from the dynamically registered client network device for a time interval that exceeds a threshold, the master network device can determine that the dynamically registered client network device is no longer part of the communication network. The threshold may be predetermined, configurable, or adaptive. In some embodiments, the master network device transmits a message to a dynamically registered client network device that may have left the communication network. If the master network device does not receive a response from the dynamically registered client network device after a predetermined number of retransmissions, the master network device may determine that the dynamically registered client network device is no longer part of the communication network. The master network device can discard any registration information associated with the dynamically registered client network device.

In some embodiments, the master network device reserves a set of communication slots to assign to the dynamically registered client network devices. After dynamically registering a client network device in the communication network, the master network device can assign one or more of the reserved communication slots to the dynamically registered client network device. The master network device can transmit a management message to notify all the client network devices in the communication network regarding the communication slots allocated to the dynamically registered client network device.

In some communication networks, unencrypted messages that are transmitted over the vehicular electric wiring may be detected by sniffing messages on the electric wiring (e.g., using power outlets in the vehicle). To provide security, the messages that are transmitted over the vehicular electric wiring may be encrypted and an encryption key may be distributed to the network devices in the communication network. These and other operations for securely exchanging messages will be described in FIGS. 5, 6, and 7.

FIG. 5 is a flow diagram 500 illustrating example operations for encrypting a message. The flow 500 begins at block 502.

At block 502, a first network device of a communication network determines to transmit a message to a second network device during a first communication slot of a beacon period. The first network device may be a client network device in communication with a master network device or another client network device, or the first network device may be the master network device in communication with a client network device. The first communication slot may be a contention-based communication slot that the first network device gained control during a contention interval. Alternatively, the first communication slot may be a contention-free communication slot that was allocated by a master network device to the first network device for transmitting messages. The flow continues at block 504.

At block 504, the first network device determines an encryption key for encrypting the message based, at least in part, on characteristics of the message. The encryption key may be a DEK and/or a GEK received in the registration information from the master network device. The registration information may also indicate which encryption key should be used to encrypt a message based, at least in part, on the type of the message, the communication slot in which the message will be transmitted, the second (receiving) network device, and/or other suitable factors. The first network device may select an appropriate encryption key depending on the characteristics of the message that will be transmitted. The characteristics of the message may refer to the type of message that will be transmitted, the receiving network device(s), the type of communication slot in which the message will be transmitted, the identifier of the communication slot in which the message will be transmitted, and/or other suitable factors. The type of communication slot may refer to whether the message will be transmitted in a contention-based or a contention-free communication slot. For example, the first network device may use a first encryption key for transmitting messages in contention-free communication slots and a second encryption key for transmitting messages in contention-based communication slots. As another example, the first network device may use a first encryption key for communicating with a first group of receiving network devices and a second encryption key for communicating with a second group of receiving network devices. As another example, the first network device may use the DEK to transmit a unicast message to the second network device. As another example, the first network device may select a suitable GEK to transmit data to the second network device.

In some embodiments, the first network device combines the DEK or a GEK with information in a beacon message to generate the encryption key. As discussed above, a beacon period may be associated with a beacon period identifier that is indicated in the beacon message. At each beacon period, the master network device may increment the beacon period identifier and include the incremented beacon period identifier in a corresponding beacon message. The first network device may combine the DEK/GEK with the beacon period identifier to generate the encryption key. For example, the first network device may use a suitable hashing algorithm to combine the DEK or GEK with the beacon period identifier to generate the encryption key. In other embodiments, other suitable combining operations (e.g., concatenation, Boolean logic operations, etc.) may be executed to combine the DEK/GEK with the beacon period identifier and generate the encryption key. The flow continues at block 506.

At block 506, the first network device determines an initialization vector (IV) for encrypting the message based, at least in part, on information in the beacon message. The first network device may determine the IV based, at least in part, on the beacon period identifier and a slot identifier of the communication slot that will be used for transmitting the message. If multiple contiguous communication slots will be used to transmit the message, the slot identifier of one of the communication slots (e.g., the first communication slot, the last communication slot, etc.) may be used to determine the IV. For example, the communication slot offset may be determined as a function of the number of contiguous communication slots. Alternatively, if multiple contiguous communication slots will be used to transmit the message, a communication slot offset may be used to determine the IV. In some embodiments, the length (e.g., number of bits) of the IV depends on the block length of a block code used by the encryption mechanism, or on state information of one or more stream ciphers used by the encryption mechanism. For example, the combination of the beacon period identifier and the slot identifier may be hashed with or without a shared secret (e.g., using a suitable hashing algorithm) to determine the IV. The shared secret may also be referred to as a “hash key.” The master network device may provide the hash key as part of the registration information, in the beacon message, or another suitable management message. The hash key may be provided at start-up, on demand, and/or at periodic intervals. It is noted that other suitable combining operations (e.g., concatenation, Boolean logic operations, etc.) may be executed to determine the IV. Furthermore, in some embodiments, the second (receiving) network device may determine and provide the IV to the first (transmitting) network device in an unencrypted message.

In some embodiments, the information that is used to determine the IV is padded so that the resultant IV has a predetermined length. The length of the IV may be predetermined based, at least in part, on the encryption mechanism being used. For example, the block size may be 128 bits (regardless of the hash key length) when advanced encryption standard (AES) is used for encryption. Therefore, the IV may also be 128 bits. If the beacon period identifier is represented using 64 bits and the slot identifier is represented using 9 bits, concatenating the beacon period identifier and the slot identifier yields 64+9=73 bits (which is less than the expected length of the IV). Accordingly, the resultant 73 bits may be padded with an additional 55 bits (“pad bits”) to generate a 128-bit IV. In some embodiments, the master network device transmits the pad bits (e.g., in a beacon message) at start-up or at periodic intervals. In other embodiments, a predetermined set of pad bits (e.g., a set of zeros) are used. The hash key may be distinct from the pad bits, may be a subset of the pad bits, or may encompass the pad bits. Also, the hash key and/or the pad bits may be different for each encryption key or for a subset of the encryption keys. If the hash function generates a greater number of output bits (as a hash value) than is required by the IV, the hash value may be truncated to generate the predetermined number of bits of the IV. For example, a 256-bit secure hash algorithm (SHA-256) yields a hash value of 256 bits. The 256-bit hash value can be truncated to generate a 128-bit IV for encryption using AES. It is noted that in other embodiments, the length of the IV may be configurable.

In some embodiments, the first network device determines a different IV depending on which encryption key is being used for encryption, the type of message being transmitted, the receiving network devices, the communication slot in which the message will be transmitted, and/or other suitable factors. Additionally, the same IV that was used for an original transmission of the message may be used to encrypt subsequent retransmissions of the message to facilitate recombining at the second network device. The flow continues at block 508.

At block 508, the first network device encrypts the message for transmission to the second network device based, at least in part, on the encryption key and the initialization vector. The first network device may also determine a cryptographic message integrity code (MIC) for the message that will be transmitted. In one embodiment, the MIC is a linear checksum such as a cyclic redundancy check (CRC) value when a suitable block cipher is used in cipher block chaining (CBC) mode. In other embodiments, the MIC is a true cryptographic hash when a block cipher is used in a stream mode. The MIC may be determined across a payload portion of the message or across a frame control portion and the payload portion of the message. The payload portion may also be referred to as “data portion” of the message. The MIC may also be referred to as “error check portion” of the message. The MIC may be appended to the payload portion to form the resultant message for transmission. The payload portion and the MIC of the message may be encrypted using the encryption key and the IV. For example, the first network device may use 128-bit AES in the CBC mode (e.g., as indicated in the HomePlug GreenPHY communication protocol) to encrypt the message for transmission. It is noted that in other embodiments, the first network device may use another suitable encryption mechanism. The first network device may then transmit the message over the communication medium (e.g., an automotive bus in a vehicle). From block 508, the flow ends.

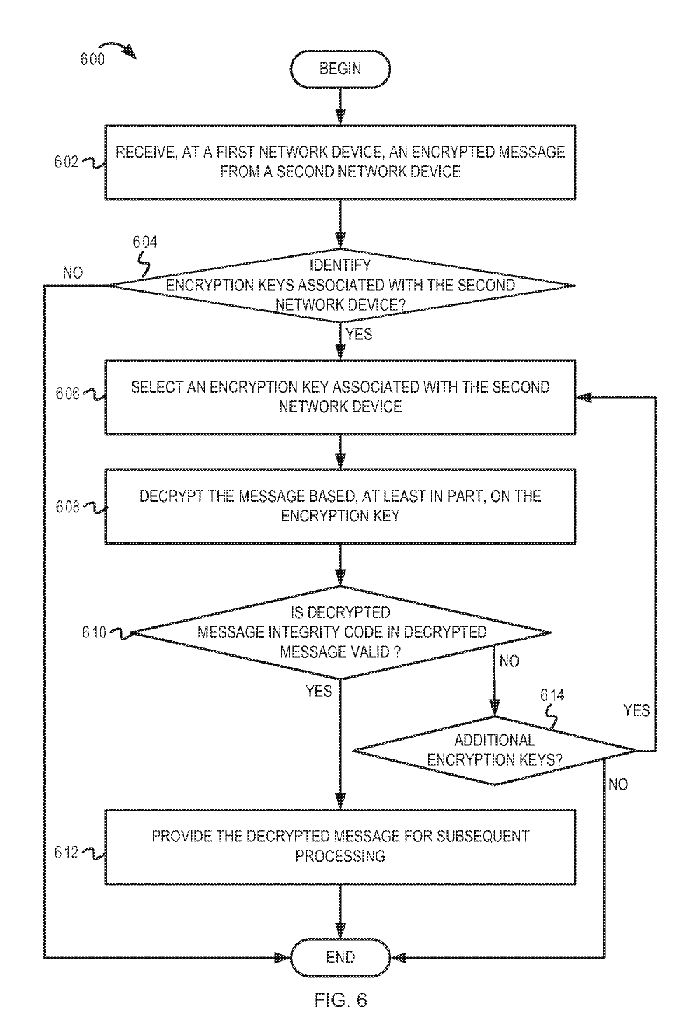

FIG. 6 is a flow diagram 600 illustrating example operations for decrypting a message. The flow 600 begins at block 602.

At block 602, a first network device receives an encrypted message from a second network device. The first network device may be a client network device in communication with a master network device or another client network device, or the first network device may be the master network device in communication with a client network device. The encrypted message may include an encrypted payload portion and an encrypted MIC. In some implementations, depending on the encryption mechanism, the MIC may be a CRC value. The flow continues at block 604.

At block 604, the first network device determines whether it can identify encryption keys associated with the second network device. In some embodiments, the second network device is associated with multiple encryption keys. The second network device may have a DEK for unicast communication with the first network device. The second network device may also have multiple GEKs for transmitting broadcast/multicast management messages or data messages to other network devices. The second network device may use a different GEK to encrypt the message depending on the receiving network devices, the communication slots in which the message is transmitted, the type of message being transmitted, and/or other suitable factors. Because the second network device can be associated with multiple encryption keys, there may be some ambiguity at the first network device regarding which encryption key was used by the second network device to encrypt the message. The first network device may identify all the encryption keys (e.g., DEK and GEKs) that are associated with the second network device. Then, from the encryption keys that are associated with the second network device, the first network device may identify a subset of the encryption keys that are valid for the type of received message and/or the communication slot in which the message was received. The first network device may perform further analysis on the subset of the encryption keys, as will be further described below. If the first network device identifies encryption keys associated with the second network device, the flow continues at block 606. If the first network device cannot identify any encryption keys associated with the second network device, the first network device may discard the message and the flow ends.

At block 606, the first network device selects an encryption key associated with the second network device. Referring to the above example, a subset of the encryption keys associated with the second network device may be valid for the type of received message and/or the communication slot in which the message was received. In this example, the first network device may select an encryption key from the subset of the encryption keys to attempt to decrypt the received message. The flow continues at block 608.

At block 608, the first network device decrypts the message received from the second network device based, at least in part, on the selected encryption key. The first network device may use a suitable decryption algorithm along with the encryption key to decrypt the message. In some embodiments, the first network device also determines an IV for decrypting the message. The IV that is used for decrypting the message at the first network device may be the same as the IV that was used for encrypting the message at the second network device. For example, the IV may be a random/pseudo-random number that may be indicated in the beacon message, derived from information indicated in a message (e.g., information indicated in the beacon messages), and/or derived from information associated with the message (e.g., communication slot in which the message in received). As another example, the IV may be determined as a combination of a beacon period identifier and a slot identifier of the communication slot in which the message was received. As another example, the first network device may receive the IV in plain-text (i.e., unencrypted) from the second network device. It is noted that other suitable techniques and beacon message information may be used to determine the IV at the first network device. In some embodiments, the first network device iteratively uses each possible combination of encryption key and IV (known to the first network device) to decrypt the message. The first network device may determine a decrypted MIC from the decrypted message. The flow continues at block 610.

At block 610, the first network device determines whether the decrypted MIC is valid. Validating the MIC can help indicate whether the received message was both decoded and decrypted correctly using the encryption key. If the decrypted MIC is not valid, this can indicate that either the message was incorrectly decoded or the message was incorrectly decrypted. In other words, an invalid MIC can indicate that the encryption key that was used for decryption is different from the encryption key that was used for encryption. If the decrypted MIC is valid, the flow continues at block 612. If the decrypted MIC is not valid, the flow continues at block 614.

At block 612, if the decrypted MIC is valid, the first network device provides the decrypted message for subsequent processing. For example, the first network device may analyze the decrypted payload portion of the message and execute operations indicated in the decrypted payload portion. As another example, the first network device may re-encrypt the message and relay the message in the communication network. From block 612, the flow ends.

At block 614, if the decrypted MIC is not valid, the first network device determines whether there are additional encryption keys associated with the second network device to analyze. Referring to the above example, a subset of the encryption keys associated with the second network device may be valid for the type of received message and/or the communication slot in which the message was received. In this example, the first network device may determine whether to use another encryption key from the subset of the encryption keys to decrypt the received message. If there are additional encryption keys to analyze, the flow loops back to block 606, where the first network device selects another encryption key. If the first network device has unsuccessfully attempted to decrypt the message using all the valid encryption keys, the flow ends.

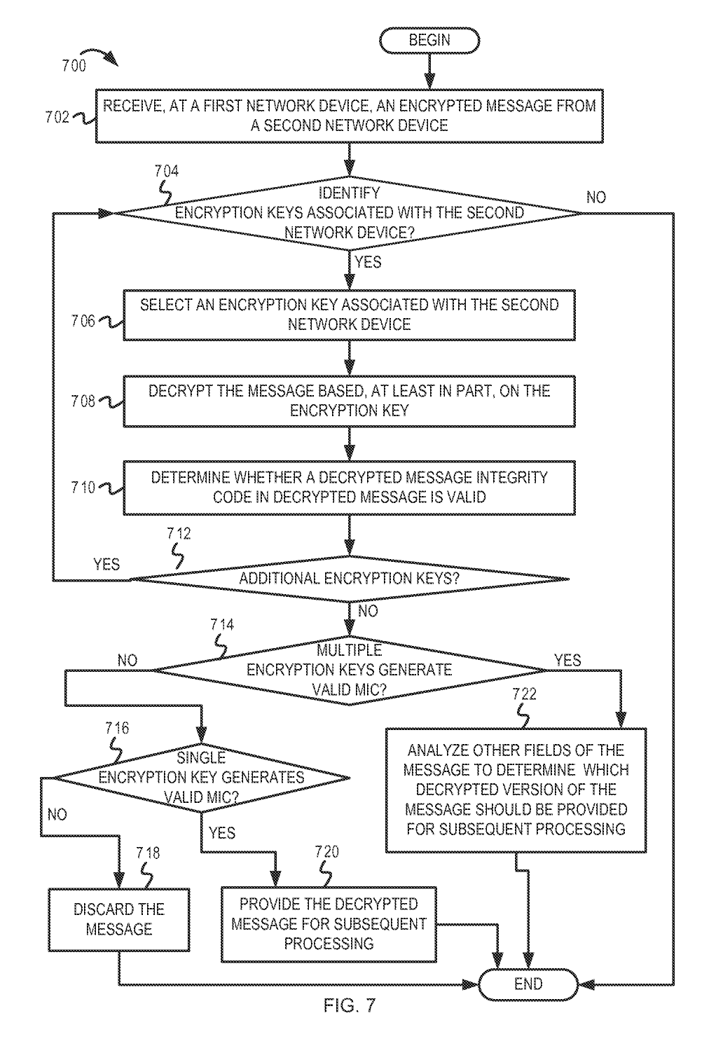

FIG. 7 is a flow diagram 700 illustrating example operations for decrypting a message. The flow begins at block 702.

At block 702, a first network device receives an encrypted message from a second network device. For example, the first network device may be a client network device that is communicating with the second network device that may be a master network device or another client network device. As another example, the first network device may be the master network device that is communicating with a client network device. The encrypted message may include an encrypted payload portion and an encrypted MIC. The flow continues at block 704.

At block 704, the first network device determines whether it can identify encryption keys associated with the second network device. For example, the first network device may identify all the encryption keys that are associated with the second network device. The first network device may then identify a subset of the encryption keys that are valid, as similarly described above with reference to FIG. 6. If the first network device identifies encryption keys associated with the second network device, the flow continues at block 706. If the first network device cannot identify any encryption keys associated with the second network device, the first network device may discard the message and the flow ends.

At block 706, the first network device selects an encryption key associated with the second network device. For example, a subset of the encryption keys associated with the second network device may be valid for the type of received message and/or the communication slot in which the message was received. In this example, the first network device may select an encryption key from the subset of the encryption keys to attempt to decrypt the received message. The flow continues at block 708.

At block 708, the first network device decrypts the message received from the second network device based, at least in part, on the selected encryption key. The first network device may use a suitable decryption algorithm along with the encryption key to decrypt the message. The first network device may also determine an IV for decrypting the message, as similarly described above with reference to FIG. 6. The first network device may determine a decrypted MIC from the decrypted message. The flow continues at block 710.

At block 710, the first network device determines whether the decrypted MIC is valid. Validating the MIC can indicate whether the received message was both decoded and decrypted correctly using the encryption key. An invalid MIC can indicate that the encryption key that was used for decryption is different from the encryption key that was used for encryption. In some embodiments, the first network device stores an indication of whether the decrypted MIC associated with the encryption key and the IV is valid or invalid. In other embodiments, the first network device stores an indication of the encryption key and the IV if the decrypted MIC was valid. The flow continues at block 712.

At block 712, the first network device determines whether there are additional encryption keys associated with the second network device to analyze. Referring to the above example, the first network device may determine whether to use another encryption key from the subset of the encryption keys to decrypt the received message. Additionally, the first network device can iteratively use each possible combination of encryption key and IV (known to the first network device) to decrypt the message. If there are additional encryption keys (or combinations of encryption key and IV) to analyze, the flow loops back to block 706, where the first network device selects another encryption key (or another combination of encryption key and IV). If all the encryption keys (or combinations of encryption keys and IVs) have been used to decrypt the message, the flow continues at block 714.

At block 714, if all the encryption keys have been used, the first network device determines whether multiple encryption keys generated a valid MIC. Decrypting a message using an encryption key may yield a valid MIC at the first network device even though the second network device used a different encryption key to encrypt the message. To minimize the possibility of false positives, the first network device may use each encryption key associated with the second network device to decrypt the message. The first network device can keep track of which encryption key (or combination of encryption key and IV) generated a valid MIC. If multiple encryption keys generated a valid MIC, the flow continues at block 722. Otherwise, the flow continues at block 716.

At block 716, if multiple encryption keys did not generate a valid MIC, the first network device determines whether a single encryption key generated the valid MIC. If only one encryption key generated a valid MIC, the flow continues at block 720. otherwise, the first network device can determine that none of the encryption keys (or combinations of encryption key and IV) generated a valid MIC. In this case, the flow continues to block 718.

At block 718, if none of the encryption keys generated a valid MIC, the first network device discards the message. If the first network device unsuccessfully attempted to decrypt the message using all the valid encryption keys (or combinations of encryption key and IV), the first network device can discard the message. From block 718, the flow ends.

At block 720, if only one encryption key generated a valid MIC, the first network device provides the decrypted message for subsequent processing. If only one encryption key yields a valid MIC, the first network device may determine that this encryption key was originally used by the second network device. The first network device may then analyze the decrypted payload portion of the message and execute operations indicated in the decrypted payload portion. In some embodiments, the first network device is a relay device that is configured to relay the messages received from the second network device. After validating the MIC associated with the decrypted message, the first network device may re-encrypt the message and relay the encrypted message in the communication network. From block 720, the flow ends.

At block 722, if multiple encryption keys generated a valid MIC, the first network device analyses other fields of the message to determine which decrypted version of the message should be provided for subsequent processing. If multiple encryption keys yield a valid MIC, the first network device may determine that at least one of the multiple encryption keys incorrectly generated a valid MIC. The first network device may use other suitable techniques (such as invalid message field values or combinations of values) to determine which encryption key was originally used at the second network device. For each decrypted message that generated a valid MIC, the first network device may compare a message field value against an expected value. If there is a mismatch, the first network device may discard the decrypted message. If there is a match, the first network device may provide the decrypted message for processing. For example, a decrypted message may be discarded if other message fields indicate an unexpected message type, incorrect field values, incorrect combinations of field values, etc. The decrypted message that is not discarded may be provided for subsequent processing. From block 722, the flow ends. In some embodiments, the first network device may determine that the decrypted message generated by each of the encryption keys that generated the valid MIC is incorrect. Accordingly, the first network device may determine that the message is invalid and cannot be decrypted. The first network device may then discard the message.

In some embodiments, in FIGS. 6 and 7, if a client network device receives a unicast message from the master network device, the client network device may use its DEK to decrypt the received message. If the client network device receives an unencrypted message, the client network device may validate the MIC to determine whether to process or discard the message. For other messages that are received from another client network device, the client network devices may execute the operations described above in blocks 604-614 or blocks 704-722.

Various medium access techniques may be supported for PLC automotive bus communication (PLC-AB traffic). For example, contention-free access techniques, contention-based access techniques, and contention reservation request/contention-free access (CRR-CFA) may be supported. The master network device may allocate communication slots to a client network device based, at least in part, on the medium access techniques that will be used to transmit a message on the communication medium.

In some embodiments, a master network device allocates communication slots for contention-free access (CFA) of a communication medium. These communication slots may also be referred to as “CFA communication slots” or “contention-free communication slots.” The master network device may allocate these communication slots in response to a request from a client network device or after registering the client network device in a communication network. The contention-free communication slots may be allocated to a single client network device in the communication network. The master network device may use a slot allocation schedule to indicate the contention-free communication slots allocated to one or more client network devices in the communication network. The master network device may also indicate the type, latency, period, and/or other transmission parameters of messages that may be transmitted in the contention-free communication slot.

FIG. 8 depicts an example slot allocation schedule illustrating assignment of communication slots. The master network device may divide a beacon period into sub-intervals, and each sub-interval may be further divided into communication slots (also referred to as “communication time slots”). FIG. 8 depicts an example graph of sub-intervals within a beacon period (Y-axis) versus communication slots per sub-interval (X-axis). In the example of FIG. 8, the beacon period is 20 ms and the beacon period is divided into 2 ms sub-intervals (depicted on the Y-axis). Thus, the 20 ms beacon period shown in FIG. 8 comprises ten 2 ms sub-intervals staring with a 0-2 ms sub-interval and ending with an 18 ms-20 ms sub-interval. Each sub-interval shown in FIG. 8 is divided into 32 communication slots (depicted on the X-axis) such that each communication slot is 62.5 μs. It is noted that the beacon period, the sub-intervals within the beacon period, and/or the communication slots may have other suitable duration. In some implementations, the master network device may allocate contention-free communication slots based on either latency parameters or time cycle (i.e., period) parameters-whichever is shorter. The master network device allocates ten contention-free communication slots in a 20 ms beacon period for transmitting messages with 2 ms latency. The master network device allocates two contention-free communication slots in a 20 ms beacon period for transmitting messages with 10 ms latency. The master network device allocates one contention-free communication slot in a 20 ms beacon period for transmitting messages with 20 ms latency. It is noted that the master network device may assign communication slots that are different from those depicted in FIG. 8 depending on the communication slots previously assigned by the master network device. Furthermore, the master network device may use other types of transmission information to allocate communication slots to the client network device. For example, the master network device may allocate contention-free communication slots to the client network device based, at least in part, on the type of messages transmitted by the client network device.

The client network device may transmit messages during the contention-free communication slots allocated to the client network device. The client network device may not transmit messages during the contention-free communication slots that are allocated to another client network device. The master network device may reserve communication slots in anticipation of future requests from client network devices for contention-free communication slots. For example, with reference to FIG. 8, the master network device may reserve communication slots 9-11 for each sub-interval of each beacon period in anticipation of future requests from client network devices. The number of communication slots that are reserved for future allocation of contention-free communication slots may be predefined and configurable.

Certain types of messages may be transmitted less frequently in the communication network. For example, door lock/unlock messages, ignition start/stop messages, etc. may be transmitted less frequently in the communication network than the entertainment system messages. Accordingly, the master network device may designate one or more communication slots as contention-based communication slots for transmitting these infrequent messages. In some embodiments, a contention-based communication slot is a communication slot that is allocated for collision-free contention access (CFCA) of the communication medium (“CFCA communication slot”). The client network device may identify the CFCA communication slot based, at least in part, on registration information transmitted by a master network device of the communication network. Referring to the example of FIG. 8, communication slots 8, 9, and 10, during the 6-8 ms sub-interval of the beacon period may be allocated as CFCA communication slots. For CFCA, the master network device may assign a priority resolution indicator (also referred to as “PRI” or “priority level”) to the client network device. The priority resolution indicator may be rotated/updated in a predetermined manner (e.g., rotated in a random order or a defined order) so that the client network device has a different priority resolution indicator for each beacon period (or for a predetermined number of beacon periods). The priority resolution indicator may be used to contend for control of the CFCA communication slots.

In another embodiment, the contention-based communication slot is a communication slot that is allocated for randomized priority contention access (RPCA) of the communication medium (“RPCA communication slots”). The client network device may identify the RPCA communication slot based, at least in part, on registration information transmitted by the master network device or information in a beacon message transmitted by the master network device. Referring to the example of FIG. 8, communication slots 12, 13, and 14 during the 8-10 ms sub-interval of the beacon period may be allocated for randomized priority contention access of the communication medium. For RPCA, the master network device may not assign a priority resolution indicator to the client network device. Instead, the client network device may randomly generate a priority resolution indicator to contend for control of the RPCA communication slot. Alternatively, the client network device may randomly select the priority resolution indicator from a range of priority resolution indicators assigned by the master network device. The client network device may randomly generate a new priority resolution indicator each time it contends for control of an RPCA communication slot.

A contention-based communication slot may include a contention interval followed by a message transmission interval and an inter-frame spacing (IFS). During the contention interval, client network devices that are assigned the same contention-based communication slot contend with each other to gain control of that contention-based communication slot. The contention-based communication slot may be a CFCA communication slot or an RPCA communication slot depending on whether the client network devices are assigned a priority resolution indicator by the master network device or whether the client network devices randomly select a priority resolution indicator. In other embodiments, any client network device may contend for control of a contention-based communication slot, such as an RPCA communication slot that is dynamically allocated by the master network device. A client network device may implement priority contention using priority resolution symbols (PRS) to determine whether it can gain control of the contention-based communication slot. The priority resolution symbols associated with the client network device may be determined based, at least in part, on the priority resolution indicator associated with the client network device. In one example, the priority resolution indicator is a fixed bit-length integer value. The fixed bit-length integer value may be an array of bits PRI[0], PRIM, and so on, where PRI[0] represents the most significant bit of the integer value. The contention interval of the contention-based communication slot may be sub-divided into multiple PRS signaling slots. The client network device may transmit a predefined symbol (or other predefined signal) in a PRS signaling slot if the corresponding priority resolution symbol has a value=1. The client network device may determine not to transmit the predefined symbol in the PRS signaling slot when the corresponding priority resolution symbol has a value=0. The client network device may listen for transmissions from other client network devices when the client network device does not transmit the predefined symbol in the PRS signaling slot. The client network device may gain control of the contention-based communication slot if priority resolution symbols are not detected from another client network device. Referring to the above example, the client network device may transmit a PRS in PRS signaling slot i if the following two conditions are satisfied—(a) PRI[i]=1 for the client network device, and (b) the client network device has not detected a PRS in any PRS slot j, j<i, for which PRI[j]=0. The client network device may transmit a management message or a data message during the message transmission interval after gaining control of the contention-based communication slot. The client network device may relinquish control of the contention-based communication slot if priority resolution symbols are detected from another client network device.

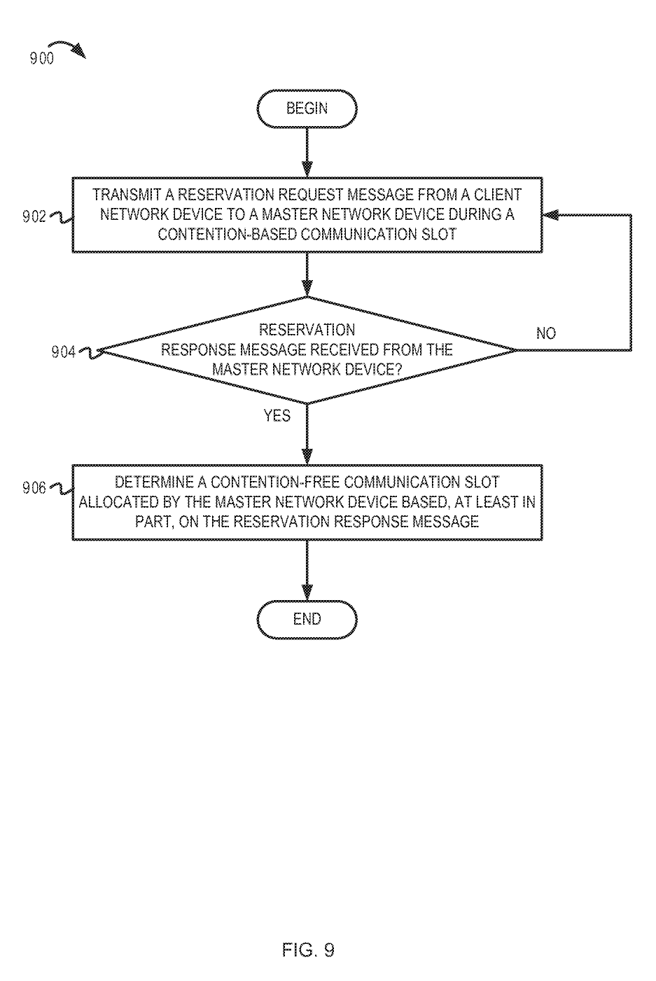

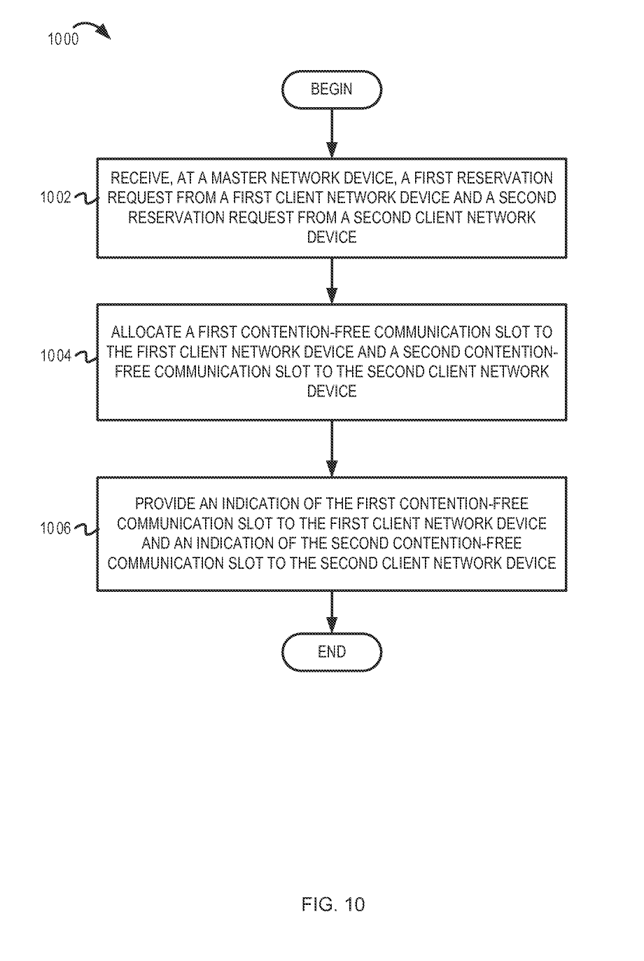

The CRR-CFA mechanism may be a hybrid medium access technique that combines the features of contention-free access and the contention-based access of the communication medium. The CRR-CFA mechanism can be used to allow the master network device to dynamically allocate temporary contention-free communication slots to a client network device, as will be further described below in FIGS. 9 and 10.

FIG. 9 is a flow diagram 900 illustrating example operations for contention reservation request/contention-free access of a communication medium. The flow 900 begins at block 902.

At block 902, a client network device transmits a reservation request to a master network device during a contention-based communication slot. For example, the client network device may transmit the reservation request in the contention-based communication slots that are allocated for transmission of reservation requests. These communication slots may be indicated in the slot allocation schedule. Referring to FIG. 8, communication slots 8, 9, and 10, during the 6-8 ms sub-interval of the beacon period may be contention-based communication slots allocated for transmission of reservation requests. The client network device may execute priority contention operations to contend for control of the contention-based communication slot. The client network device may use a priority resolution indicator that is assigned by the master network device or a priority resolution indicator that is randomly selected by the client network device. The reservation request may include a reservation request identifier, the number and frequency of the contention-free communication slots being requested, and/or the duration of the transmission. The client network device may increment the reservation request identifier each time it transmits a new reservation request. The flow continues at block 904.

At block 904, the client network device determines whether a reservation response was received from the master network device. The client network device may listen for a reservation response during a contention-free communication slot that is allocated to the master network device and/or during a communication slot that is allocated for transmitting reservation responses (e.g., indicated in the slot allocation schedule). Referring to FIG. 8, communication slot 12 during each sub-interval of the beacon period may be a contention-free communication slot allocated to the second network device for transmitting reservation responses. If the reservation response is received, the flow continues at block 906. If the client network device does not receive the reservation response, the flow loops back to block 902 where the client network device retransmits the reservation request. The client network device may retransmit the reservation request when the client network device gains control of another contention-based communication slot.

At block 906, the client network device determines a contention-free communication slot allocated by the master network device based, at least in part, on the reservation response. The reservation response may include the reservation request identifier that was included in the reservation request, an indication of contention-free communication slots temporarily allocated to the client network device, and the duration for which the contention-free communication slots have been allocated. The contention-free communication slots may be allocated from a pool of communication slots that are reserved for the CRR-CFA mechanism. The client network device may then transmit one or more messages in the temporarily allocated contention-free communication slots. From block 906, the flow ends.

FIG. 10 is a flow diagram 1000 illustrating example operations for processing multiple reservation request messages. The flow 1000 begins at block 1002.

At block 1002, a master network device receives a first reservation request from a first client network device and a second reservation request from a second client network device. The first client network device may contend for and gain control of a first contention-based communication slot, and transmit the first reservation request in the first contention-based communication slot. The second client network device may contend for and gain control of a second contention-based communication slot, and transmit the second reservation request in the second contention-based communication slot. As discussed above, the first reservation request and the second reservation request may each include a request for one or more contention-free communication slots. The flow continues at block 1004.

At block 1004, the master network device allocates a first contention-free communication slot to the first client network device and a second contention-free communication slot to the second client network device based, at least in part, on the first reservation request and the second reservation request. In some embodiments, the master network device processes the reservation requests sequentially—in the order in which they are received. For example, the master network device may process the first reservation request and allocate a first set of contention-free communication slots to the first client network device. Next, the master network device may process the second reservation request and allocate a second set of contention-free communication slots to the second client network device. In another embodiment, the master network device processes multiple reservation requests in parallel. For example, the master network device may simultaneously process both the first and the second reservation requests to allocate the first set of contention-free communication slots and the second set of contention-free communication slots. The flow continues at block 1006.

At block 1006, the master network device provides an indication of the first contention-free communication slot to the first client network device and an indication of the second contention-free communication slot to the second client network device. In one example, the master network device provides the indication of the first contention-free communication slot and the indication of the second contention-free communication slot in the same reservation response. In the example described above, the master network device allocates the first set of contention-free communication slots and the second set of contention-free communication slots in the same reservation response, irrespective of whether the first reservation request and the second reservation request are processed sequentially or in parallel. From block 1006, the flow ends.

Although FIG. 10 describes processing reservation requests and allocating contention-free communication slots for two client network devices, in other embodiments the master network device can process reservation requests received from any suitable number of client network devices. It is noted that the master network device may indicate the contention-free communication slots allocated to each client network device in separate reservation responses irrespective of whether the reservation requests are processed sequentially or in parallel. Furthermore, the master network device may process other types of messages (e.g., registration messages) as similarly described in FIG. 10.

In some embodiments, the client network device performs priority contention operations using a predetermined priority resolution indicator instead of transmitting a reservation request to the master network device. The predetermined priority resolution indicator may represent a reservation request and may be determined by prior agreement between the client network device and the master network device. A client network device that implements the CRR-CFA mechanism may be assigned a unique priority resolution indicator or a unique range of priority resolution indicators that represents the reservation request. The client network device may select a priority resolution indicator from the assigned range to perform the priority contention operations that indicate a reservation request transmission. A contention-based communication slot may be allocated for performing priority contention operations that indicate reservation request transmission. The master network device may determine that a client network device is transmitting a reservation request in response to detecting the priority resolution indicator from the client network device during the allocated contention-based communication slot. The master network device can determine which client network device transmitted the reservation request based, at least in part, on the priority resolution indicator that was used for transmitting the reservation request. The master network device may access a data structure to determine reservation parameters associated with the client network device. For example, based on information in the data structure, the master network device may determine how many contention-free communication slots should be assigned, for how long the contention-free communication slots should be assigned, how often the contention-free communication slots should be assigned, etc. The master network device can then transmit a reservation response to the client network device, as similarly described above with reference to FIG. 9

Repeating and relaying may be used to improve the probability that all network devices in the communication network reliably receive and decode a message that is transmitted in the communication network. “Repeating” can refer to multiple transmissions of the same message by a network device that originally transmitted the message (“original transmitting network device”). Repeating can increase the probability that a receiving network device successfully receives at least one copy of the message. Repeating a message can also allow a receiving network device to use receive recombining to improve decoding reliability. Additionally, the original transmitting network device may retransmit a message in multiple communication slots to improve transmission reliability. “Relaying” can refer to retransmitting a message that was previously received by a network device from another network device. Relaying can mitigate the effects of “hidden nodes” and marginal links. The network devices that are configured to retransmit messages received from the original transmitting network device may be referred to as “relay devices” or “repeater devices.” The relay devices may receive an original transmission of a message from the original transmitting network device. The relay devices may then retransmit the message in subsequent communication slots allocated to the original transmitting network device. The relay device may determine the communication slot that is assigned to the original transmitting network device from a retransmission schedule (or a slot allocation schedule) received from the master network device. The relay device may simultaneously retransmit the message during the same communication slot when the original transmitting network device retransmits the message. It is noted that the relay device transmitting the message may also be referred to as the relay device retransmitting (or repeating) the original transmission of the message. A receiving network device may also use the retransmission schedule (or the slot allocation schedule) to reliably receive and decode a message. Because the content of the original transmission and the retransmissions of the message are the same, multiple copies of the message appear to the receiving network devices as multipath without hindering the ability of the receiving network device to decode the messages.

In some embodiments, a master network device designates a relay device to relay the reservation request. For example, the master network device may allocate two contention-based communication slots (e.g., CFCA communication slots or RPCA communication slots) for transmitting reservation requests. The first contention-based communication slot may be assigned to a first group of client network devices that can reliably communicate with each other, but not with the master network device. The second contention-based communication slot may be assigned to a second group of client network devices that can reliably communicate with each other and also with the master network device. Any client network device in the second group may operate as a relay device for a client network device in the first group. In response to detecting a reservation request from a first client network device in the first group, a second client network device in the second group may attempt to gain control of the second contention-based communication slot. The second client network device may relay the reservation request after gaining control of the second contention-based communication slot.

In some embodiments, the reservation responses are also retransmitted by the master network device and/or by a relay device. The slot allocation schedule may indicate the contention-free or contention-based communication slots that may be used for retransmitting the reservation responses. The relay device may detect a reservation response transmitted by the master network device and may retransmit the reservation response during the allocated communication slot. If the client network device that transmitted a reservation request has a weak/poor communication link with the master network device, the client network device may receive the reservation response via the relay device.

In some embodiments, the messages transmitted by the client network device in the contention-free communication slots (allocated in the CRR-CFA mechanism) are also repeated/relayed. The reservation response may indicate the communication slots in which these messages can be repeated/relayed and which relay devices should relay the messages that were transmitted in the contention-free communication slots. The communication slots that are allocated for the original transmission and retransmissions of the message may be part of the same beacon period or may be spread across multiple beacon periods.

In some embodiments, the master network device designates one or more client network devices as registration relay devices. The registration relay devices may include those client network devices that can reliably communicate with the master network device. The master network device may also allocate one or more communication slots for relaying registration requests. A registration relay device may detect a registration request transmitted by an unregistered client network device. The registration relay device may retransmit the registration request during the allocated communication slot. If a contention-based communication slot is allocated for retransmitting registration requests, the registration relay device may retransmit the registration request (originally transmitted by the unregistered client network device) after gaining control of the contention-based communication slot. Alternatively, a contention-free communication slot may be allocated for relaying the registration request. The master network device may also allocate one or more contention-free or contention-based communication slots for relaying registration responses. The registration relay device may detect a registration response transmitted by the master network device and may retransmit the registration response during the allocated communication slot.

It should be understood that FIGS. 1-10 are examples meant to aid in understanding embodiments and should not be used to limit embodiments or limit scope of the claims. Embodiments may comprise additional circuit components, different circuit components, and/or may perform additional operations, fewer operations, operations in a different order, operations in parallel, and some operations differently. Although examples describe operations for adaptively allocating communication slots and for secure message communication in a PLC environment, the operations described herein may be extended to other communication networks and communication protocols. For example, the operations for adaptively allocating communication slots and secure message communication may be executed by network devices that implement WLAN communication protocols (e.g., IEEE 802.11 communication protocols), MoCA communication protocols, Ethernet communication protocols, G.hn home networking protocols, Bluetooth® communication protocols, and so on. In other embodiments, the operations described above may be extended to a combination of communication protocols. For example, the operations for adaptively allocating communication slots and secure message communication may be executed using a combination of PLC protocols and WLAN communication protocols.

In some embodiments, the vehicle 200 of FIG. 2 is an electric vehicle that is coupled with a charging station (not shown). The charging station may include one or more network devices configured similarly to the network device 102 of FIG. 1. The network devices of the electric vehicle and the charging station may use S-MAP for communications between the electric vehicle and the charging station during assigned communication slots. For example, the network devices may exchange messages between the electric vehicle and the charging station for health and status information, command/control information, billing information, etc. The network devices within the electric vehicle may form a first internal PLC network, such as a first internal HomePlug AV network. Likewise, network devices within the charging station may form a second internal PLC network, such as a second HomePlug AV network. The network devices of the electric vehicle and the network devices of the charging station may form a third PLC network when the electric vehicle is connected to (or plugged into) the charging station.

As will be appreciated by one skilled in the art, aspects of the present disclosure may be embodied as a system, method, or computer program product. Accordingly, aspects of the present disclosure may take the form of an entirely hardware embodiment, a software embodiment (including firmware, resident software, micro-code, etc.) or an embodiment combining software and hardware aspects that may all generally be referred to herein as a “circuit,” “module,” “unit,” or “system.” Furthermore, aspects of the present disclosure may take the form of a computer program product embodied in one or more computer readable medium(s) having computer readable program code embodied thereon.

Any combination of one or more non-transitory computer readable medium(s) may be utilized. Non-transitory computer-readable media comprise all computer-readable media, with the sole exception being a transitory, propagating signal. The non-transitory computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code embodied on a computer readable medium for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

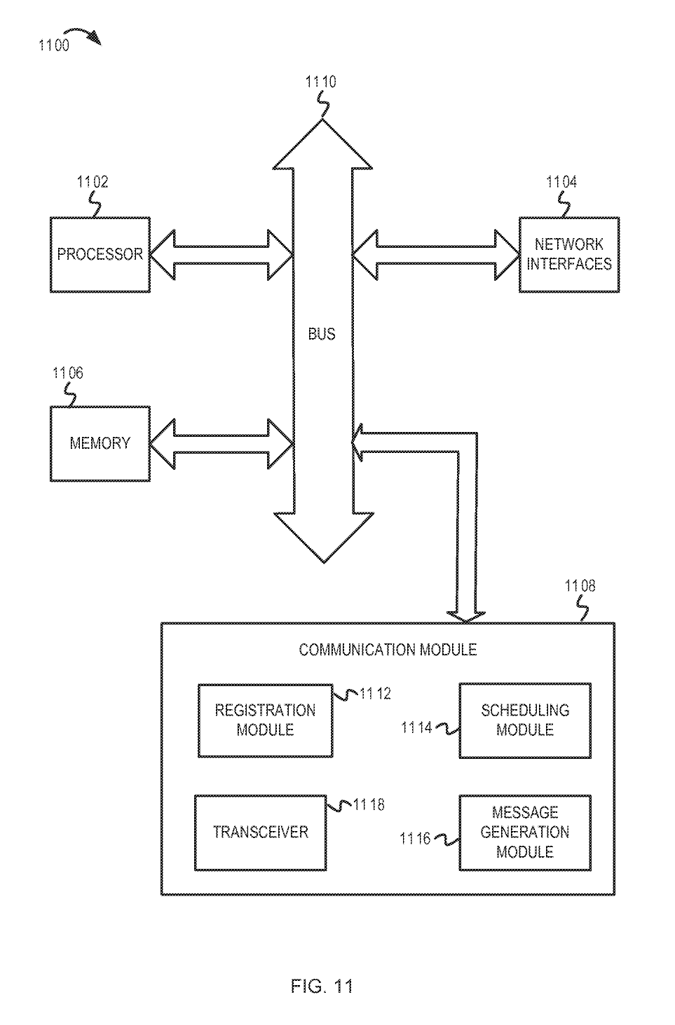

FIG. 11 is a block diagram of one embodiment of an electronic device 1100 including a slot allocation mechanism for communication. In some embodiments, the electronic device 1100 is a communication component within a system, such as a plug-in electric vehicle (PEV), a hybrid electric vehicle, a gas-powered vehicle, an electric vehicle supply equipment (EVSE or charging station), an aircraft, electronic machinery, or another system with communication capabilities. In another embodiment, the electronic device 1100 is a desktop computer, a laptop computer, a tablet computer, a mobile phone, a smart appliance, a PLC device, a gaming console, a network bridging device, an access point, an electric vehicle, a gas-powered vehicle, a charging station, or other electronic device with communication capabilities. The electronic device 1100 includes a processor 1102 which can include multiple processors, multiple cores, multiple nodes, and/or implementing multi-threading, etc. The electronic device 1100 includes memory 1106. The memory 1106 may be system memory (e.g., one or more of cache, SRAM, DRAM, zero capacitor RAM, Twin Transistor RAM, eDRAM, EDO RAM, DDR RAM, EEPROM, NRAM, RRAM, Silicon-Oxide-Nitride-Oxide-Silicon (SONOS), PRAM, etc.) or any one or more of the above already described possible realizations of computer-readable storage media. The electronic device 1100 also includes a bus 1110 (e.g., Peripheral Component Interconnect (PCI), Industry Standard Architecture (ISA), PCI-Express, HyperTransport®, InfiniBand®, NuBus, Advanced High-performance Bus (AHB), Advanced eXtensible Interface (AXI), etc.), and network interface 1104 that include at least one of a wireless network interface (e.g., a WLAN interface, a Bluetooth® interface, a WiMAX interface, a ZigBee® interface, a Wireless USB interface, etc.) and a wired network interface (e.g., a PLC interface, an Ethernet interface, etc.). The processor 1102, the memory 1106, and the network interface 1104 are coupled to the bus 1110.

The electronic device 1100 also includes a communication module 1108. The communication module 1108 includes a registration module 1112, a scheduling module 1114, a message generation module 1116, and a transceiver 1118. The registration module 1112 may execute operations to register a network device in the communication network and determine one or more encryption keys for subsequent communication, as described above with reference to FIGS. 3 and 4. The message generation module 1116 may encrypt and decrypt messages for secure communication of messages as described above with reference to FIGS. 5, 6, and 7. The message generation module 1116 may also generate a message using a suitable message format for transmission in the communication network. The scheduling module 1114 may allocate communication slots to network devices for contention-free access and/or contention-based access of the communication medium as described above in FIGS. 8-10. The transceiver 1118 may include a receiver and a transmitter as described above with reference to FIG. 1. In some embodiments, the transceiver 1118 is implemented as part of the network interface 1104. In other embodiments, the transceiver 1118 is implemented separate from the network interface 1104 or the communication module 1108 and may be coupled with the bus 1110.

Any one of these functionalities may be partially (or entirely) implemented in hardware and/or on the processor 1102. For example, the functionality may be implemented with a system-on-a-chip (SoC), an application specific integrated circuit (ASIC), in logic implemented in the processor 1102, in a co-processor on a peripheral device or card, etc. Further, realizations may include fewer or additional components not illustrated in FIG. 11 (e.g., video cards, audio cards, additional network interfaces, peripheral devices, etc.). For example, in addition to the processor 1102 coupled with the bus 1110, the communication module 1108 may include at least one additional processor. As another example, the communication module 1108 may include one or more radio transceivers, processors, memory, and other logic to implement the communication protocols and related functionality. As another example, although illustrated as being coupled to the bus 1110, the memory 1106 may be coupled to the processor 1102.

While the embodiments are described with reference to various implementations and exploitations, it will be understood that these embodiments are illustrative and that the scope of the disclosure is not limited to them. In general, slot allocation techniques for transmitting messages in a communication network as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the disclosure. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the disclosure.

What is claimed is:

1. A method for network device registration, the method comprising:
determining, at a first network device of a communication network, to register a second network device in the communication network;
allocating a first communication slot of a beacon period to the second network device for a key exchange after determining to register the second network device;
determining a device encryption key associated with the second network device from the key exchange performed during the first communication slot; and
providing registration information to register the second network device in the communication network based, at least in part, on the device encryption key.

2. The method of claim 1, wherein determining to register the second network device is based, at least in part, on receiving a registration request from the second network device.

3. The method of claim 1, further comprising:
allocating the first communication slot and a second communication slot for the key exchange;
receiving a key exchange request from the second network device during the first communication slot;
transmitting a key exchange response to the second network device during the second communication slot; and
determining the device encryption key based, at least in part, on the key exchange request and the key exchange response.

4. The method of claim 1, wherein determining the device encryption key comprises:
determining a first channel characteristic based, at least in part, on a message received from the second network device during the key exchange; and
determining the device encryption key based, at least in part, on the first channel characteristic.

5. The method of claim 1, further comprising:
receiving, at the first network device, a certificate from the second network device; and
determining the device encryption key after authenticating the certificate.

6. The method of claim 1, wherein the registration information includes at least one group encryption key for encrypting communications between the second network device and a third network device of the communication network.

7. The method of claim 1, further comprising:
determining a first encryption key for encrypting a message to be transmitted to the second network device based, at least in part, on combining the device encryption key with information in a beacon message received in the beacon period.

8. The method of claim 1, wherein the registration information includes at least one member selected from the group consisting of:
an indication that the second network device is configured as a relay device to relay messages that are transmitted from a third network device, and
an encryption key associated with the third network device for decrypting the messages received from the third network device.

9. The method of claim 1, further comprising:
receiving, at the first network device, a reservation request from the second network device during a contention-based communication slot; and
allocating a contention-free communication slot to the second network device based, at least in part, on the reservation request.

10. The method of claim 9, wherein the reservation request comprises at least one member selected from the group consisting of reservation request identifier, a number of contention-free communication slots being requested, and a duration for which contention-free communication slots are being requested.

11. The method of claim 1, further comprising:
receiving, at the first network device, a first reservation request from the second network device during a first contention-based communication slot and a second reservation request from a third network device during a second contention-based communication slot;
allocating a first contention-free communication slot to the second network device and a second contention-free communication slot to the third network device based, at least in part, on the first reservation request and the second reservation request; and
providing an indication of the first contention-free communication slot to the second network device and an indication of the second contention-free communication slot to the third network device in a same reservation response.

12. The method of claim 1, wherein the first network device and the second network device are included in the communication network of a vehicle.

13. The method of claim 1, wherein the first network device and the second network device are configured to implement at least one powerline communication (PLC) protocol.

14. A method for message encryption, the method comprising:
determining, at a first network device of a communication network, to transmit a first message to a second network device during a first communication slot of a beacon period;
determining a first encryption key for encrypting the first message based, at least in part, on characteristics of the first message;
determining an initialization vector for encrypting the first message based, at least in part, on information in a beacon message received from a coordinating network device of the communication network; and
encrypting the first message for transmission to the second network device based, at least in part, on the first encryption key and the initialization vector.

15. The method of claim 14, wherein determining the first encryption key comprises:
identifying a plurality of initial encryption keys received at the first network device from the coordinating network device; and
selecting a first initial encryption key from the plurality of initial encryption keys based, at least in part, on at least one member selected from the group consisting of
a type of the first message,
whether the first communication slot is a contention-based communication slot or a contention-free communication slot, and
an identifier of the second network device.

16. The method of claim 15, further comprising:
determining the first encryption key based, at least in part, on combining the first initial encryption key with the information in the beacon message.

17. The method of claim 14, wherein determining the initialization vector comprises:
determining the initialization vector based, at least in part, on combining an identifier of the first communication slot and an identifier of the beacon period that includes the first communication slot.

18. The method of claim 14, wherein encrypting the first message comprises:
generating an encrypted first message for transmission based, at least in part, on encrypting a combination of a data portion of the first message and an error check portion of the first message.

19. The method of claim 14, further comprising:
receiving a second message at the first network device from the second network device during a second communication slot;
determining a plurality of encryption keys that are associated with the second network device, wherein the plurality of encryption keys are received at the first network device from the coordinating network device; and
selecting, for decrypting the second message, at least a second encryption key from the plurality of encryption keys based, at least in part, on the second message and the second communication slot.

20. The method of claim 19, further comprising:
selecting the second encryption key and a third encryption key from the plurality of encryption keys based, at least in part, on the second message and the second communication slot; and
for each of the second encryption key and the third encryption key,
decrypting the second message based, at least in part, on a corresponding encryption key; and
determining whether the second message was successfully decrypted based, at least in part, on the decrypted second message.

21. The method of claim 19, further comprising:
determining a decrypted error check portion of the decrypted second message based, at least in part, on decrypting the second message using the second encryption key;
determining whether the decrypted error check portion is valid;
determining that the second message was successfully decrypted in response to determining that the decrypted error check portion is valid; and
determining that the second message was not successfully decrypted and discarding the second message in response to determining that the decrypted error check portion is not valid.

22. The method of claim 14, further comprising:
determining, at the first network device, a contention-based communication slot of the beacon period;
transmitting, during the contention-based communication slot, a reservation request from the first network device to the coordinating network device;
receiving a reservation response from the coordinating network device; and
determining a contention-free communication slot from the reservation response, wherein the contention-free communication slot is allocated by the coordinating network device based, at least in part, on the reservation request.

23. The method of claim 22, further comprising:
executing contention operations in the contention-based communication slot to gain control of the contention-based communication slot based, at least in part, on a priority level associated with the first network device,
wherein transmitting the reservation request is based, at least in part, on gaining control of the contention-based communication slot.

24. The method of claim 22, wherein the reservation response is received at the first network device via a third network device of the communication network, wherein the third network device is configured to relay the reservation response originally transmitted by the coordinating network device.

25. The method of claim 22, wherein the reservation request comprises at least one member selected from the group consisting of reservation request identifier, a number of contention-free communication slots being requested, and a duration for which contention-free communication slots are being requested.

26. A first network device of a communication network, comprising:
a processor; and
a memory to store instructions, which when executed by the processor, cause the first network device to:
determine to register a second network device in the communication network;
allocate a first communication slot of a beacon period to the second network device for a key exchange after determining to register the second network device;
determine a device encryption key associated with the second network device from the key exchange performed during the first communication slot; and
provide registration information to register the second network device in the communication network based, at least in part, on the device encryption key.

27. The first network device of claim 26, wherein the instructions further cause the first network device to:
allocate the first communication slot and a second communication slot for the key exchange;
receive a key exchange request from the second network device during the first communication slot;
transmit a key exchange response to the second network device during the second communication slot; and
determine the device encryption key based, at least in part, on the key exchange request and the key exchange response.

28. The first network device of claim 26, wherein the instructions further cause the first network device to:
determine a first channel characteristic based, at least in part, on a message received from the second network device during the key exchange; and
determine the device encryption key based, at least in part, on the first channel characteristic.

29. A first network device of a communication network, comprising:
a processor; and
a memory to store instructions, which when executed by the processor, cause the first network device to:
determine to transmit a first message to a second network device during a first communication slot of a beacon period;
determine a first encryption key for encrypting the first message based, at least in part, on characteristics of the first message;
determine an initialization vector for encrypting the first message based, at least in part, on information in a beacon message received from a coordinating network device of the communication network; and
encrypt the first message for transmission to the second network device based, at least in part, on the first encryption key and the initialization vector.

30. The first network device of claim 29, wherein causing the first network device to determine the first encryption key comprises causing the first network device to:
identify a plurality of initial encryption keys received at the first network device from the coordinating network device;
select a first initial encryption key from the plurality of initial encryption keys based, at least in part, on at least one member selected from the group consisting of
a type of the first message,
whether the first communication slot is a contention-based communication slot or a contention-free communication slot, and
an identifier of the second network device; and
determine the first encryption key based, at least in part, on combining the first initial encryption key with the information in the beacon message.
